(19) United States
(12) Patent Application Publication
(10) Pub. No.: US 2024/0239090 A1
(43) Pub. Date: Jul. 18, 2024

(54) STRETCHABLE FLAME RESISTANT MATERIALS

(71) Applicant: W. L. Gore & Associates GmbH, Putzbrunn (DE)

(72) Inventors: Peter Wimmer, Putzbrunn (DE); Bernd Zischka, Tuntenhausen (DE)

(21) Appl. No.: 18/559,269

(22) PCT Filed: May 4, 2022
(86) PCT No.: PCT/EP2022/062046

§ 371 Date: Nov. 6, 2023

Related U.S. Application Data
(60) Provisional application No. 63/184,557, filed on May 5, 2021.

(51) Int. Cl. B32B 27/12; B32B 3/28; B32B 5/02; B32B 27/34; B32B 27/36; B32B 37/14

(52) U.S. Cl. CPC B32B 27/12; B32B 3/28; B32B 5/02; B32B 27/34; B32B 27/36; B32B 37/144; B32B 2262/106; B32B 2307/3065; B32B 2307/51; B32B 2327/18; B32B 2437/00

(57) ABSTRACT

Disclosed herein are laminates including a textile layer that is elastic and including a meltable material; a barrier layer, and an intermediate layer located between the textile layer and the barrier layer, the intermediate layer including a heat reactive material, wherein the heat reactive material includes a polymer resin-expandable graphite mixture of a polymer resin and an expandable graphite, the expandable graphite having an expansion of at least 900 pm at 280° C., and wherein the laminate is configured to be stretched an amount of at least 10% by a stretching force and to recover at least 80% of the amount stretched when the stretching force is released. The barrier layer may have less than 5% elasticity and may be defined a corrugated structure within the laminate.

### CROSS-REFERENCE TO RELATED APPLICATION

This application is a national phase application of PCT Application No. PCT/EP2022/062046, internationally filed on May 2, 2022, which claims the benefit of Provisional Application No. 63/184,557, filed May 5, 2021, which are herein incorporated by reference in their entireties for all purposes.

### FIELD

The present disclosure relates to burn protective materials, and more particularly, to stretchable flame resistant laminates with high flame-resistant additives, and methods for making the same. More specifically, the disclosure relates to stretchable burn protective laminates, which are air impermeable and permeable to water vapor, for use as form-fitting articles of protective clothing and other end uses.

### BACKGROUND

To reduce fire related burn injuries, protective clothing is desired for professionals working in hazardous environments where exposure to fire is possible, such as search and rescue, and police professionals. Protective gear for workers exposed to these conditions should provide some enhanced protection to reduce the risk of more serious injury and to potentially to help allow the wearer to get away from a fire hazard after exposure.

Traditionally, flame resistant protective garments have been made with an outermost layer of an ensemble (the flame-contacting layer) including non-combustible, non-melting fabric made of, for example, aramids, polybenzimidazole (PBI), poly p-phenylene-2,6-benzobisoxazole (PBO), modacrylic blends, polyamines, carbon, polyacrylonitrile (PAN), and blends and combinations thereof. These fabrics may be inherently flame resistant but may have several limitations. Specifically, these fabrics may be very expensive, difficult to dye and print, and may not have adequate abrasion resistance. Additionally, these fabrics pick up more water and offer unsatisfactory tactile comfort as compared to nylon or polyester based fabrics.

Various advancements in flame resistant garments have been made. As one example, U.S. Pat. No. 10,364,527 (Panse et.al.) describes a textile composite including a flammable, meltable material, and a heat reactive material including a polymer resin-expandable graphite mixture.

In environments with occasional flash fire exposure and where flexibility of movement is essential, lightweight, stretchable breathable, garments with enhanced burn protection are desired along with soft and drapeable feeling. Burn protective clothing articles which are form fitting allow for a closer fit without adversely affecting the wearers comfort. The cost of flame resistant, protective clothing has been an important consideration for the large number of hazardous exposure applications outside fire protection, thereby precluding the use of typical, inherently flame-resistant textiles such as those used in firefighting community.

### SUMMARY

Provided are burn protective materials, and more particularly, stretchable flame resistant laminates with high flame-resistant additives, and methods for making the same.

According to one aspect (“Aspect 1”), there is provided a laminate including a textile layer that is elastic and comprises a meltable material; a barrier layer, and an intermediate layer located between the textile layer and the barrier layer, the intermediate layer including a heat reactive material. The heat reactive material includes a polymer resin-expandable graphite mixture of a polymer resin and an expandable graphite, the expandable graphite having an expansion of at least 900 μm at 280° C. The laminate is optionally configured to be stretched an amount of at least 10% by a stretching force and to recover at least 80% of the amount stretched when the stretching force is released. In some embodiments, the laminate is optionally configured to be stretched an amount of at least 5% by a stretching force and to recover at least 80% of the amount stretched when the stretching force is released.

A wide variety of elastic textiles can be utilized in the laminate, however for most applications it is highly desirable that the stretchable laminate constructions not be too stiff so as to offer excessive resistance to body movements. It has been determined that elastic textiles requiring a force to elongate to 200% of their relaxed length of from about 0.2 kg/cm width to about 0.3 kg/cm width are suitable for preparing stretchable laminate constructions that can be stretched to 200% of their relaxed length by a force of less than about 0.6 kg/cm width. Elastic textiles having a stretchability of greater than 10% when a stretching force is applied and which recover at least 80% of the amount stretched when the stretching force is released may be used.

The textile layer may include one or more of: a woven, a knit, a non-woven material, or a combination thereof. The textile layer may be a multilayer textile including one or more of woven, knit and/or nonwoven textiles. Elastic textiles may include woven, nonwoven or knitted fabrics. The elastic textiles may include hard or non-elastic fiber and an elastic fiber. Suitable hard fibers include synthetic fibers such as polyamides, for example nylon, nylon 6, nylon 6.6; polyester, polyethylene terephthalate, polytrimethylene terephthalate, polybutylene terephthalate; polyurethane; polyolefin, polyethylene, polypropylene, and elastane fibers or naturally occurring fibers such as cotton.

The textile layer may have a stretchability of greater than 10% when a stretching force is applied and which recover at least 80% of the amount stretched when the stretching force is released may be used.

The textile layer may have a hydrophobic treatment to help lower the water absorption of the laminate. Suitable hydrophobic treatments may include, fluorochemical treatments and/or silicone-based treatments, for example.

The textile layer may have an insecticidal or insect repellant treatment applied, for example, permethrin or DEET, for example.

The textile layer may have a hydrophilic or oleophobic treatments in order to impart water-wicking or dirt-repelling properties to the laminate.

The meltable material may include polyamides, for example nylon, nylon 6, nylon 6.6; polyester, polyethylene terephthalate, polytrimethylene terephthalate, polybutylene terephthalate; polyurethane; polyolefin, polyethylene, polypropylene, elastane and combinations thereof. The meltable material may include a polyester or a polyamide having at least some aliphatic groups. The meltable material may be produced from aliphatic diols, diamines and diacids.

The meltable material may be flammable, and include but are not limited to polyamides such as nylon 6 or nylon 6,6, polyester, and polyproplyene.

The barrier layer may include a polymeric membrane or a textile.

The polymeric membrane may include a fluoropolymer, a polyolefin, a polyester, a polyamide, a polyurethane, a copolyetherester, a copolyetheramide, a polysulfone or a polyetheretherketone. The fluoropolymer can include expanded polytetrafluoroethylene (ePTFE) or polytetrafluoroethylene (PTFE).

The barrier layer can be a thermally stable film or a thermally stable textile layer. The barrier layer may be a combination of a textile layer and a thermally stable textile layer.

The barrier layer may one or more of: an aramid, flame resistant cotton, cotton, flax, cuprammonium rayon (cupro), acetate, triacetate, wool, viscose, polybenzimidazole (PBI), polybenzoxazole (PBO), FR rayon, modacryl, modacryl/cotton blend, polyamine, fiberglass, polyacrylonitrile, nylon, polyester or polypropylene fibers or a combination thereof.

The intermediate layer may be applied to the textile layer. The intermediate layer may be applied to the barrier layer. The intermediate layer may be applied to both the textile layer and the barrier layer. The intermediate layer may be applied in a continuous pattern. The intermediate layer may be applied in a discontinuous pattern. A discontinuous layer of the intermediate layer may have less than 100% surface coverage. Applying the intermediate layer as a discontinuous layer may enhance air-permeability, water vapor permeability and/or hand.

The discontinuous pattern of the intermediate layer may include any suitable shape or form. For example, the pattern may include one or more of dots, circles, squares, rectangles, triangles, stars, diamonds, pentagons, hexagons, heptagons, octagons, polygons, ovals, hearts, grids, lines, waves, zig-zag lines, combinations thereof and the like. The intermediate layer may be applied to the textile layer or the barrier layer in a discontinuous pattern of dots.

A discontinuous application of the intermediate layer may provide less than 100% surface coverage by forms including but not limited to dots, grids, lines, and combinations thereof. As used herein, the term “dot” means any shape that may be any discrete shape, for example, one or more of a circle, a square, a rectangle, a triangle, a star, a diamond, a pentagon, a hexagon, a heptagon, an octagon, a polygon, an oval, a heart and the like. The lines may have a straight shape, a corrugated shape, a curved shape or mixtures thereof. Depending on the pattern, the dots and lines may be arranged closer to or further apart from each other. The lines may be arranged in the form of a grid.

The intermediate layer may be applied in a discontinuous dot pattern. The dots may have a diameter in the range of greater than or equal to from about 0.8 mm to about 5 mm. The dots may have a diameter in the range of from about 0.9 mm to about 4.5 mm. The dots have a diameter in the range of from about 1.0 mm to about 4.0 mm. The dots may have a diameter in the range of from about 1.0 mm to about 3.5 mm. The dots may have a diameter in the range of from about 1.0 to about 3.0 mm. The dots may have a diameter in the range of from about 1.0 mm to about 2.5 mm. The dots may have a diameter in the range of from about 1.0 mm to about 2.25 mm. The dots may have a diameter in the range of from about 1.0 mm to about 2.2 mm. The dots may have a diameter in the range of from about 1.0 mm to about 2.1 mm. The dots may have a diameter in the range of from about 1.0 mm to about 2.0 mm.

In some embodiments with discontinuous coverage, the average distance between adjacent areas of the discontinuous pattern is less than the size of an impinging flame. In some embodiment with discontinuous coverage, the average distance between adjacent areas of the discontinuous pattern is less than 10 mm, or less than 5 mm, or preferably less than 3.5 mm, or 2.5 mm or less, or 1.5 mm or less, or 0.5 mm or less. For example, in a dot pattern printed onto a substrate, the spacing between the dots would be measured. An average distance between adjacent areas of the discontinuous pattern may be greater than 40 μm, or greater than 50 μm, or greater than 100 μm, or greater than 200 μm, depending on the application. Average dot spacing measured to be greater than 200 μm and less than 500 μm is useful in some laminates described herein.

Pitch may be used, for example, in combination with surface coverage as a way to describe the laydown of a printed pattern. In general, pitch is defined as the average center-to-center distances between adjacent forms such as dots, lines, or gridlines of the printed pattern. The average is used, for example, to account for irregularly spaced printed patterns. The intermediate layer may be applied discontinuously in a pattern with a pitch and surface coverage that provides superior flame retardant performance compared to a continuous application of the intermediate layer having a laydown of equivalent weight of the intermediate layer. The pitch may be defined as the average of the center-to-center distances between adjacent shapes of the heat reactive composition. For example, the pitch may be defined as the average of the center-to-center distances between adjacent dots or grid lines of the intermediate layer. The pitch may be equal or greater than about 500 μm, equal or greater than about 600 μm, equal or greater than about 700 μm, equal or greater than about 800 μm, equal or greater than about 900 μm, equal or greater than about 1000 μm, equal or greater than about 1200 μm, equal or greater than about 1500 μm, equal or greater than about 1700 μm, equal or greater than about 1800 μm, equal or greater than about 2000 μm, equal or greater than about 3000 μm, equal or greater than about 4000 μm, or equal or greater than about 5000 μm, or equal or greater than about 6000 μm or any value therebetween. A preferred pattern of the intermediate layer may have pitch from about 500 μm to about 6000 μm.

The intermediate layer may cover in the range of from about 20% to about 100% of the surface area of the textile layer and/or the barrier layer. The intermediate layer may cover in the range of from about 25% to about 80% of the surface area of the textile layer and/or the barrier layer. The intermediate layer may cover in the range of from about 25% to about 75% of the surface area of the textile layer and/or the barrier layer. The intermediate layer may cover in the range of from about 25% to about 55% of the surface area of the textile layer and/or the barrier layer. The intermediate layer may cover in the range of from about 25% to about 40% of the surface area of the textile layer and/or the barrier layer. The intermediate layer may cover in the range of from about 25% to about 35% of the surface area of the textile layer and/or the barrier layer.

The intermediate layer may cover in the range of from about 30% to about 100% of the surface area of the textile layer and/or the barrier layer. The intermediate layer may cover in the range of from about 45% to about 100% of the surface area of the textile layer and/or the barrier layer. The intermediate layer may cover in the range of from about 55% to about 100% of the surface area of the textile layer and/or the barrier layer. The intermediate layer may cover in the range of from about 65% to about 100% of the surface area of the textile layer and/or the barrier layer. The intermediate layer may cover in the range of from about 70% to about 100% of the surface area of the textile layer and/or the barrier layer. The intermediate layer may cover in the range of from about 95% to about 100% of the surface area of the textile layer and/or the barrier layer.

The intermediate layer may cover in the range of from about 30% to about 70% of the surface area of the textile layer and/or the barrier layer. The intermediate layer may cover in the range of from about 45% to about 65% of the surface area of the textile layer and/or the barrier layer. The intermediate layer may cover in the range of from about 25% to about 50% of the surface area of the textile layer and/or the barrier layer. The intermediate layer may cover in the range of from about 65% to about 90% of the surface area of the textile layer and/or the barrier layer. The intermediate layer may cover in the range of from about 70% to about 80% of the surface area of the textile layer and/or the barrier layer.

These ranges of coverage of the layers with an intermediate layer of less than 100% of the surface area may improve properties of the laminate such as air-permeability, hand, breathability, and/or laminate weight. For example, applying the intermediate layer to the textile layer and/or the barrier layer in a deposition from about 20% to about 95% may result in a laminate with increased air-permeability, breathability, increased hand and decreased weight compared to a laminate in which the intermediate is applied as a continuous layer with 100% coverage of the surface area of the textile and/or barrier layer.

Methods for achieving a coverage of less than 100% of the surface area may include applying or printing the intermediate layer including the heat reactive material onto a surface of the textile layer or the barrier layer or both. Suitable application, printing or deposition methods for the heat reactive material include, but are not limited to, screen printing, rotary screen printing, gravure printing, spray or scatter coating, or knife coating. Screen printing or rotary screen printing of the heat reactive material may allow for a higher laydown (when compared to the laydown that can be achieved by a gravure roll) and a low percent area coverage which can allow for a relatively high air permeability of the textile laminate. Using this method, the thickness of the screens may be increased because the heat reactive material may include a liquid, for example, water, a solvent or a dispersant. However, after printing, at least a portion of the liquid may be removed (i.e., evaporated) from the heat reactive material using a heat source, for example, an oven or a heated roll. When liquid is removed from the heat reactive material during heating, the mass of the heat reactive material may be reduced, resulting in a lighter textile laminate. When at least a portion of the liquid of the heat reactive material is removed, the mass of the heat reactive material may be reduced as much as about 20% or as much as about 25% or as much as about 30% or as much as about 35% or as much as about 40% or as much as 45%, when compared to the mass of the heat reactive material prior to removal of the liquid.

Upon exposure of the laminate to flames and/or heat, for example, a temperature greater than or equal to about 280° C., the meltable material may begin to melt and the melt may mix with the heat reactive material, especially with the expanding graphite. This process can also form a char of the meltable material and the heat reactive material. The char resulting from exposure of the meltable material and the heat reactive material to heat and/or high temperatures, for example, greater than or equal to about 280° C., may be a heterogeneous melt mixture including at least the meltable material and the expanded expandable graphite. A char, according to this disclosure, is meant to refer to the carbonaceous material remaining after exposing the meltable material and the heat reactive material to a temperature of greater than or equal to about 280° C. At temperatures greater than or equal to about 280° C., one or both of the meltable material and the polymeric resin may also oxidize or participate in the combustion process forming additional carbonaceous material that becomes part of the char. The formation of the char can help to insulate the layers below of the char from exposure to heat.

The heat reactive material, upon expansion, may form a plurality of tendrils including expanded graphite. During the expansion process, the total volume of the heat reactive material may increase significantly when compared to the same mixture prior to expansion. The volume of the heat reactive material may be increased at least about five times after expansion. The volume of the heat reactive material may be increased at least about six times after expansion. The volume of the heat reactive material may be increased at least about seven times after expansion. The volume of the heat reactive material may be increased at least about eight times after expansion. The volume of the heat reactive material may be increased at least about nine times after expansion. The volume of the heat reactive material may be increased at least about ten times after expansion.

Where the laminate includes a textile layer, a barrier layer and an intermediate layer including the heat reactive material applied in a pattern of discontinuous forms, the heat reactive material may expand forming tendrils that are loosely packed after expansion creating voids between the tendrils, as well as space between the pattern of the expanded heat reactive material. Upon exposure to flame, the meltable material may melt and generally move away from the open areas between the discontinuous forms of the heat reactive material. The barrier layer and/or a backer layer may support the heat reactive material during expansion and the melt of the textile layer and/or meltable material may be absorbed and retained by the expanding heat reactive material during melting. By absorbing and retaining the melt, the laminate described herein may exhibit no melt-dripping. By absorbing and retaining the melt, the laminate described herein may be non-flammable, as measured by the Horizontal Flame Test described herein. Where a barrier layer supports the expanding heat reactive material during melt absorption, the thermally stable backer layer may be protected from breaking open and hole formation. The increased surface area of the heat reactive material upon expansion may allow for absorption of the melt from the textile layer by the expanded heat reactive material upon exposure to flame.

In some embodiments, the laminate may exhibit no melt drip, no hole formation and no spreading of the flame or glow to the edges thereof.

The heat reactive material can include a polymer resin-expandable graphite mixture of a polymer resin and an expandable graphite.

Polymer resins having a melt or softening temperature of less than 280 degrees centigrade are suitable for use in disclosed embodiments. In one embodiment polymer resins described herein are sufficiently flowable or deformable to allow the expandable graphite to expand substantially upon heat exposure at or below 300 degrees centigrade, preferably at or below 280 degrees centigrade. Other polymer resins suitable for use in the heat reactive material allow the expandable graphite to sufficiently expand at temperatures below the pyrolysis temperature of the meltable outer textile. It may be desirable that the extensional viscosity of a polymer resin is low enough to allow for the expansion of expandable graphite and high enough to maintain the structural integrity of the heat reactive material after expansion of the mixture of polymer resin and expandable graphite. In another embodiment a polymer resin is used which has a storage modulus between 103 and 108 dyne/cm2 and Tan delta between about 0.1 and about 10 at 200 degrees centigrade. In another embodiment a polymer resin is used that has a storage modulus between 103 and 106 dyne/cm2. In another embodiment a polymer resin is used that has a storage modulus between 103 and 104 dyne/cm2. Polymer resins suitable for use in some embodiments have a modulus and elongation at around 300 degrees centigrade or less, suitable to allow the graphite to expand. Polymer resins suitable for use in some embodiments are elastomeric. Other polymer resins suitable for use in some embodiments are cross-linkable, such as crosslinkable polyurethane such as that sold under the tradename “MOR-MELT” R7001E (from Rohm and Haas). In other embodiments, suitable polymer resins are thermoplastic having a melt temperature between 50 degrees centigrade and 250 degrees centigrade, such as that sold under the tradename “DESMOMELT” VP KA 8702 (from Bayer Material Science LLC). Polymer resins suitable for use in embodiments described herein include polymers which include but are not limited to polyesters, thermoplastic polyurethanes and crosslinkable polyurethanes, and combinations thereof. Other polymer resins may include one or more polymers selected from polyester, polyamide, acrylic, vinyl polymer, polyolefin. Other polymer resins may include silicone or epoxy. Flame retardant materials optionally may be incorporated in the polymer resin, such as melamine, phosphorous, and brominated compounds, metal hydroxides such as alumina trihydrate (ATH), borates, and combinations thereof. The polymer resin may be an aqueous acrylic resin.

The polymer resin may include at least 25 wt % of an aqueous acrylic resin based on the total weight of the polymer resin and at least one polymer resin that includes vinyl acetate, styrene, polyether, polyester, polyurethane, polyether polyurethane, polyester polyurethane, polycarbonate polyurethane or a copolymer or a blend thereof.

In some embodiments of the polymer resin-expandable graphite mixture, the mixture, upon expansion, forms a plurality of tendrils including expanded graphite. The total surface area of the polymer resin-expandable graphite mixture increases significantly when compared to the same mixture prior to expansion. In one embodiment, the surface area of the mixture is increased at least five times after expansion. In another embodiment, the surface area of the mixture is increased at least ten times after expansion. In addition, tendrils will often extend outward from the expanded mixture. Where the polymer resin-expandable graphite mixture is situated on a substrate in a discontinuous form, the tendrils will extend to at least partially fill the open areas between the discontinuous domains. In a further embodiment, the tendrils will be elongated, having a length to width aspect ratio of at least 5 to 1.

In one embodiment, where a laminate includes a meltable outer textile, a barrier layer and heat reactive material including a polymer resin-expandable graphite mixture applied in a pattern of discontinuous forms, the heat reactive material expands forming tendrils that are loosely packed after expansion creating voids between the tendrils, as well as space between the pattern of the expanded polymer resin-expandable mixture. Upon exposure to flame, the meltable outer textile melts and generally moves away from the open areas between the discontinuous forms of the heat reactive material. The barrier layer supports the heat reactive material during expansion and the melt of the meltable outer textile is absorbed and retained by the expanding heat reactive material during melting. By absorbing and retaining the melt, laminates can be formed that exhibit no melt-dripping and flammability is suppressed. It is believed that where the barrier layer supports the expanding material during melt absorption, the barrier layer is protected from breaking open and hole formation. The increased surface area of the heat reactive material upon expansion allows for absorption of the melt from the meltable textile by the expanded heat reactive material upon exposure to flame.

The polymer resin-expandable graphite mixture may be produced by a method that provides an intimate blend of polymer resin and expandable graphite, without causing substantial expansion of the expandable graphite. Suitable mixing methods include but not limited to paddle mixer, blending and other low shear mixing techniques. In one method, the intimate blend of polymer resin and expandable graphite particles is achieved by mixing the expandable graphite with a monomer or prepolymer prior to polymerization of the polymer resin. In another method, the expandable graphite may be blended with a dissolved polymer, wherein the solvent is removed after mixing. In another method, expandable graphite is blended with a hot melt polymer at a temperature below the expansion temperature of the graphite and above the melting temperature of the polymer. In methods which provide an intimate blend of polymer resin and expandable graphite particles or agglomerates of expandable graphite, the expandable graphite is coated or encapsulated by the polymer resin prior to expansion of the graphite. In other embodiments, the intimate blend is achieved prior to applying the polymer resin-expandable graphite mixture to a substrate.

Expandable graphite particle size suitable for present invention should be chosen so that the polymer resin-expandable graphite mixture may be applied with the selected application method. For example, where the polymer resin-expandable graphite mixture is applied by a gravure printing techniques, the expandable graphite particle size should be small enough to fit in the gravure cells.

The expandable graphite may expand at least about 900 micrometers upon heating to about 280° C., as measured by the TMA Expansion Test described herein.

The heat reactive material can include an FR additive. The FR additive may include nitrogen based materials and/or phosphorous based materials. The at least one FR additive may be melamine. The at least one FR additive may be polyphosphate. The at least one FR additive may be a combination of melamine and polyphosphate. The at least one FR additive may be melamine polyphosphate.

A mixture of the expandable graphite and the at least one FR additive may be present in the heat reactive material in the range of from about 5 to about 45 wt % of expandable graphite and about 5 to about 45 wt % of FR additive, based on a total weight of the heat reactive material.

The heat reactive material may include expandable graphite in the range of from about 5 to about 45 wt %, or from about 5 to about 40 wt %, or from about 5 to about 35 wt %, or from about 5 to about 30 wt %, or from about 5 to about 25 wt %, or from about 5 to about 20 wt %, or from about 5 to about 15 wt % or from about 5 to about 10 wt %. The heat reactive material may include about 10 to about 45 wt % expandable graphite, or from about 10 wt % to about 40 wt %, or from about 10 wt % to about 35 wt %, or from about 15 wt % to about 45 wt %, or from about 15 wt % to about 40 wt %, or from about 15 wt % to about 35 wt % of expandable graphite based on a total weight of the heat reactive material.

The heat reactive material may include at least one FR additive in the range of from about 5 to about 45 wt %, or from about 5 to about 40 wt %, or from about 5 to about 35 wt %, or from about 5 to about 30 wt %, or from about 5 to about 25 wt %, or from about 5 to about 20 wt %, or from about 5 to about 15 wt %, or from about 5 to about 10 wt %. The heat reactive material may include at least one FR additive in about 10 to about 45 wt % expandable graphite, or from about 10 wt % to about 40 wt %, or from about 10 wt % to about 35 wt %, or from about 15 wt % to about 45 wt %, or from about 15 wt % to about 40 wt %, or from about 15 wt % to about 35 wt % of the at least one FR additive, based on a total weight of the heat reactive material.

The heat reactive material may include acrylic polymer and a mixture of expandable graphite and at least one FR additive. The heat reactive material may include in the range of from about 40 to about 90 wt % of acrylic polymer, based on a total weight of the heat reactive material. The heat reactive material may include in the range of from about 10 to about 70 wt % of the mixture of the expandable graphite and the FR additive, based on a total weight of the heat reactive material. The heat reactive material may include in the range of from about 40 to about 80 wt % of acrylic polymer and from about 20 to about 60 wt % of the mixture of the expandable graphite and the FR additive, based on a total weight of the heat reactive material. The percentages by weight as used above are based on the total weight of the heat reactive material minus any volatiles that may be present, for example, water or other organic molecules that may evaporate during the drying and curing process.

The laminate is configured to be stretched an amount of at least 10% by a stretching force and to recover at least 80% of the amount stretched when the stretching force is released. The laminate may be stretchable in both the machine and transverse direction. The laminate is capable of stretching by at least 10%, preferably by at least 25%, and most preferably by at least 40%, of its original length in both the machine and transverse directions. In addition to the capability to stretch under a load, the laminate should also recover, in both directions, most of its original length when the stretching force is released. In some embodiments, the laminate is capable of recovering at least 50%, preferably 65%, and most preferably at least 80% of the stretched amount.

The laminate may include a backer layer providing structural support to the barrier layer. The backer layer may include one or more of: aramid, flame resistant cotton, cotton, flax, cuprammonium rayon (cupro), acetate, triacetate, wool, viscose, polybenzimidazole (PBI), polybenzoxazole (PBO), FR rayon, modacryl, modacryl/cotton blend, polyamine, fiberglass, polyacrylonitrile, polytetrafluoroethylene or a combination thereof.

The heat reactive material may include at least one polyhydroxy compound having a molecular weight of less than 1000 g/mol. The polyhydroxy compound may have a molecular weight of less than about 500 g/mol, less than about 250 g/mol, or less than about 100 g/mol. The polyhydroxy compound may be, for example, propane-1,2,3-triol.

The laminate may have a weight in the range of from about 80 to about 240 grams per square meter (g/m²). The laminate may have a weight in the range of from about 80 to about 200 g/m². The laminate may have a weight in the range of from about 80 to about 180 g/m². The laminate may have a weight in the range of from about 80 to about 165 g/m². The laminate may have a weight in the range of from about 80 to about 150 g/m². The laminate may have a weight in the range of from about 80 to about 125 g/m². The laminate may have a weight in the range of from about 80 to about 100 g/m². The laminate may have a weight in the range of from about 80 to about 90 g/m².

In other embodiments, the laminate may have a weight in the range of from 80 to 430 g/m². In other embodiments, the laminate may have a weight in the range of from 80 to 420 g/m². In other embodiments, the laminate may have a weight in the range of from 80 to 410 g/m². In other embodiments, the laminate may have a weight in the range of from 80 to 400 g/m². In other embodiments, the laminate may have a weight in the range of from 80 to 390 g/m². In other embodiments, the laminate may have a weight in the range of from 80 to 380 g/m². In other embodiments, the laminate may have a weight in the range of from 80 to 370 g/m². In other embodiments, the laminate may have a weight in the range of from 80 to 360 g/m². In other embodiments, the laminate may have a weight in the range of from 80 to 350 g/m². In other embodiments, the laminate may have a weight in the range of from 80 to 340 g/m². In other embodiments, the laminate may have a weight in the range of from 80 to 330 g/m². In other embodiments, the laminate may have a weight in the range of from 80 to 320 g/m². In other embodiments, the laminate may have a weight in the range of from 80 to 310 g/m². In other embodiments, the laminate may have a weight in the range of from 80 to 300 g/m². In other embodiments, the laminate may have a weight in the range of from 80 to 290 g/m². In other embodiments, the laminate may have a weight in the range of from 80 to 280 g/m². In other embodiments, the laminate may have a weight in the range of from 80 to 270 g/m². In other embodiments, the laminate may have a weight in the range of from 80 to 260 g/m². In other embodiments, the laminate may have a weight in the range of from 80 to 250 g/m².

The laminate may have a weight in the range of from about 95 to about 240 g/m². The laminate may have a weight in the range of from about 110 to about 240 g/m². The laminate may have a weight in the range of from about 125 to about 240 g/m². The laminate may have a weight in the range of from about 140 to about 240 g/m². The laminate may have a weight in the range of from about 165 to about 240 g/m². The laminate may have a weight in the range of from about 180 to about 240 g/m².

The laminate may have a weight in the range of about 115 to about 160 g/m². The laminate may have weight in the range of from about 95 to about 150 g/m². The laminate may have a weight in the range of from about 165 to about 190 g/m². The laminate may have a weight in the range of from about 135 to about 175 g/m². The laminate may have a weight in the range of from about 85 to about 100 g/m². All weight measurements are performed by DIN EN 12127 (1997/12).

The laminate may include a material having an air permeability of at least about 50 l/m²s, measured according to DIN ISO 9237 (1995). The laminate may include a material having an air permeability greater than about 50 l/m²s. The laminate may include a material having an air permeability from about 50 l/m²s to about 500 l/m²s, measured according to DIN ISO 9237 (1995). The laminate may include a material having an air permeability from about 75 l/m²s to about 500 l/m²s, or from about 100 l/m²s to about 500 l/m²s, or from about 125 l/m²s to about 500 l/m²s, or from about 150 l/m²s to about 500 l/m²s, or from about 175 l/m²s to about 500 l/m²s, or from about 50 l/m²s to about 100 l/m²s, or from about 75 l/m²s to about 100 l/m²s, or from about 120 l/m²s to about 150 l/m²s, or from about 130 l/m²s to about 170 l/m²s, or from about 140 l/m²s to about 180 l/m²s, or from about 150 l/m²s to about 190 l/m²s, measured according to DIN ISO 9237 (1995). Optionally, the laminate may include a material having an air permeability greater than about 150 l/m²s, measured according to DIN ISO 9237 (1995). It is understood that properties such as air permeability may be reduced for certain embodiments, depending, for example, on the specific composition of the textile layer, the barrier layer, the intermediate layer and, optionally, the backer layer.

Because the intermediate layer includes a polymeric resin in which water may be subsequently removed, the laminate may have a dry peel strength in the range of from about 5 to about 25 Newtons (N). The laminate may have a dry peel strength in the range of from about 6 to about 25 N. The laminate may have a dry peel strength in the range of from about 7 to about 25 N. The laminate may have a dry peel strength in the range of from about 7 to about 24 N. The laminate may have a dry peel strength in the range of from about 7 to about 23 N. The laminate may have a dry peel strength in the range of from about 7 to about 22 N. The laminate may have a dry peel strength in the range of from about 7 to about 21 N. The laminate may have a dry peel strength in the range of from about 8 to about 22 N. The laminate may have a dry peel strength in the range of from about 8 to about 23 N. The laminate may have a dry peel strength in the range of from about 8 to about 24 N. The laminate may have a dry peel strength in the range of from about 8 to about 25 N. The dry peel strength values are as measured in DIN 54310.

The laminate is liquid water impermeable and water vapor permeable to the extent of having a water vapor transmission rate (MVTR) of greater than about 1000 g/m2/24 hrs, or greater than about 2000, or greater than about 3000, or greater than about 5000, or greater than about 7000, or greater than about 9000, or greater than about 10000, or higher. The water vapor transmission rates are determined by the method described herein. Preferred laminates have a break open time greater than about 50 seconds, greater than about 60 seconds, or even greater than 120 seconds when tested according to the methods for Horizontal Flame Test described herein.

The laminate may have an afterflame of equal or less than about 2 seconds when tested according to the DIN EN 15025A (April 2017) test standard. The laminate may have an afterflame of equal or less than about 1.5 seconds when tested according to the DIN EN 15025A test standard. The laminate may have an afterflame of equal or less than about 1 second when tested according to the DIN EN 15025A test standard. The laminate may have an afterflame of equal or less than about 0.5 seconds when tested according to the DIN EN 15025A test standard. Upon exposure of an outer side of the textile layer to a flame, the meltable material provided within that layer may shrink away from flames. The meltable layer may melt while the heat reactive material within the intermediate layer, expands, absorbing the heat energy and the melting textile, to keep the meltable layer from burning and dripping onto the wearer. The combination of the melting of the meltable material and the expansion of the heat reactive material may allow for a lightweight stretchable laminate that is able to provide excellent comfort to a wearer and still provide protection from burns. The laminates exhibit substantially no melt dripping behavior when tested in the Horizontal Flame test.

According to another aspect (“Aspect 2”), there is provided a laminate including:
a textile layer that is elastic and includes a meltable material;
a barrier layer having less than 5% elasticity and defining a corrugated structure within the laminate; and
an intermediate layer including a heat reactive material between the textile layer and the barrier layer;
wherein the heat reactive material includes a polymer resin-expandable graphite mixture of a polymer resin and an expandable graphite, the expandable graphite having an expansion of at least 900 μm at 280° C., as measured according to the TMA expansion test.

The textile layer, described in detail above, is adhered to the barrier layer, by an intermediate layer applied to one or both of the textile layer and the barrier layer, the adherence between the two layers is such that when the laminate is under no stretching force and resting on a flat surface the barrier layer is corrugated, bunched, wrinkled, arched or puckered. In some embodiments, the adherence is also such that the laminate can be stretched at least 10% in at least one direction by a force less than that required to stretch the material forming the textile layer by the same amount by itself.

The laminate geometry remains unchanged with the barrier layer being bunched or corrugated in the machine direction and being substantially planar in the transverse direction. Where the laminate includes a backer layer as described above, the laminate appears substantially planar because the corrugated structure of the barrier layer is covered by the presence of the backer layer.

The barrier layer having less than 5% elasticity may include a polymeric membrane or a textile. The polymeric membrane may include a fluoropolymer, a polyolefin, a polyester, a polyamide, a polyurethane, a copolyetherester, a copolyetheramide, a polysulfone or a polyetheretherketone. The fluoropolymer can include expanded polytetrafluoroethylene (ePTFE) or polytetrafluoroethylene (PTFE). The barrier layer can be a thermally stable or a textile layer. The barrier layer may be a combination of a textile layer and a thermally stable textile layer. The barrier layer may include one or more of: an aramid, flame resistant cotton, cotton, flax, cupro, acetate, triacetate, wool, viscose, polybenzimidazole (PBI), polybenzoxazole (PBO), FR rayon, modacryl, modacryl/cotton blend, polyamine, fiberglass, polyacrylonitrile, nylon, polyester or polypropylene fibers or a combination thereof.

According to another aspect (“Aspect 3”) there is provided an article of clothing or an article of manufacture including the laminate of any of the preceding examples.

In one embodiment, the article of clothing may be a garment, the garment having an interior and an exterior. The laminate may be used in garments for workers in hazardous environments. The garment may have one or more of the following properties: breathable, waterproof, flame resistant, lightweight, flexible, and comfortable to wear.

The laminate may be positioned on the exterior of the garment.

The laminate may be is positioned on the interior of the garment.

Alternatively, the laminate may be positioned between the interior and exterior of the garment.

The article of manufacture may include a bivvy bag, a tent or a cover, for example.

According to another aspect (“Aspect 4”), there is a process for producing a laminate including:
imparting a stretching force on an elastic textile having an initial relaxed width in a machine direction so as to stretch the elastic textile and reduce a width of the elastic textile to 90 percent or less of the initial relaxed width;
providing a barrier layer;
applying a layer of a heat reactive material to the stretched elastic textile or the barrier layer or both; wherein the heat reactive material includes a polymer resin-expandable graphite mixture of a polymer resin and an expandable graphite, and the expandable graphite is configured to expand by at least 900 μm at 280° C.;
adhering the barrier layer to the stretched elastic textile so that the heat reactive material is between the elastic textile and the barrier layer;
curing the heat reactive material while the elastic textile remains stretched; and reducing the stretching force on the elastic textile to produce the laminate; wherein the barrier layer has a corrugated structure after the stretching force is reduced.

The application step may include applying the heat reactive material in a discontinuous pattern.

In some embodiments, the process may include applying one or more treatments to the elastic textile to improve the properties of the laminate. For example, the elastic textile may have a hydrophobic treatment to help lower the water absorption of the laminate. Suitable hydrophobic treatments can include, for example, fluorochemical treatments and/or silicone-based treatments. The elastic textile may have an insecticidal or insect repellant treatment applied, for example, permethrin or DEET. In other embodiments, the elastic textile may include hydrophilic or oleophobic treatments in order to impart the desired water-wicking or dirt-repelling properties to the laminate. Such treatments can be applied to the elastic textile prior to formation of the laminate or can be applied after formation of the laminate.

The process may include heating the laminate in an overfeed without stretching tension.

The foregoing Examples are just that, and should not be read to limit or otherwise narrow the scope of any of the inventive concepts otherwise provided by the instant disclosure. While multiple examples are disclosed, still other embodiments will become apparent to those skilled in the art from the following detailed description, which shows and describes illustrative examples. Accordingly, the drawings and detailed description are to be regarded as illustrative in nature rather than restrictive in nature.

### BRIEF DESCRIPTION OF THE DRAWINGS

The accompanying drawings are included to provide a further understanding of the disclosure and are incorporated in and constitute a part of this specification, illustrate embodiments, and together with the description serve to explain the principles of the disclosure.

FIG. 1A is a schematic view of an unstretched laminate cross-section, according to some embodiments.

FIG. 1B is a schematic view of a stretched laminate cross-section, according to some embodiments.

FIG. 2 depicts a process to make the stretchable laminate, according to some embodiments.

### DETAILED DESCRIPTION

### Definitions and Terminology

This disclosure is not meant to be read in a restrictive manner. For example, the terminology used in the application should be read broadly in the context of the meaning those in the field would attribute such terminology.

Persons skilled in the art will readily appreciate that various aspects of the disclosure can be realized by any number of methods and apparatus configured to perform the intended functions.

With respect to terminology of inexactitude, the terms “about” and “approximately” may be used, interchangeably, to refer to a measurement that includes the stated measurement and that also includes any measurements that are reasonably close to the stated measurement. Measurements that are reasonably close to the stated measurement deviate from the stated measurement by a reasonably small amount as understood and readily ascertained by individuals having ordinary skill in the relevant arts. Such deviations may be attributable to measurement error, differences in measurement and/or manufacturing equipment calibration, human error in reading and/or setting measurements, minor adjustments made to optimize performance and/or structural parameters in view of differences in measurements associated with other components, particular implementation scenarios, imprecise adjustment and/or manipulation of objects by a person or machine, and/or the like, for example. In the event it is determined that individuals having ordinary skill in the relevant arts would not readily ascertain values for such reasonably small differences, the terms “about” and “approximately” can be understood to mean plus or minus 10% of the stated value.

For purposes of this disclosure, the term “machine direction” indicates the direction of manufacture.

For purposes of this disclosure, the term “transverse direction” indicates the direction in the plane of manufacture perpendicular to the machine direction. The materials of the layers described herein are considered to be planar, defined by their length (machine direction) and width (transverse direction).

For purposes of this disclosure, the term “elastic” generally means a textile or a laminate that is able to stretch in at least one direction at least 10% and to recover at least 80% of its initial length when the stretching force is removed.

Percentage stretch is defined as % Stretch=(Ls/Lo-1)×100 and percentage recovery is defined as

$$\% Recovery = ( [ Ls - Lf ] / [ Ls - Lol ) \times 100$$

where Lo is the original length, Ls is the length when a stretching force is applied, and Lf is the length when the stretching force is released.

For purposes of this disclosure, the term “flame resistant” as used herein refers to a textile or textile laminate that exhibits an afterflame of less than about 2 seconds when subjected to the DIN EN 15025A test standard.

For purposes of this disclosure, the term “flammable” as used herein refers to textiles that have an afterflame of greater than two seconds when tested according to the Horizontal Flame Test (DIN EN ISO 15025A) for Textiles, as presented herein.

For purposes of this disclosure, the term “laminate” as used herein refers to at least two individual layers, which are bonded via an adhesive or otherwise.

For purposes of this disclosure, the term “meltable” as used herein refers to a textile or textile laminate that melts when tested according to the Melting and Thermal Stability Test at 265° C. or less, as presented herein. In some embodiments a meltable textile is one that melts, according to the Melting and Thermal Stability test disclosed herein at 285° C. or less, or melts at 290° C. or less, or melts at 300° C. or less. In alternative embodiments, a meltable textile comprises nylon, nylon 6,6, nylon 6, polyester, polyethylene terephthalate, polytrimethylene terephthalate, polypropylene terephthalate, polybutylene terephthalate, elastane, polyester ether copolymer, polyurethane, polyester urethane copolymer, polyether urethane copolymer, polyester ether urethane copolymer, polyolefin, polyethylene, polypropylene or a combination or a copolymer thereof.

For purposes of this disclosure, the term “non-flammable” as used herein refers to textiles that have an afterflame of less than or equal to two seconds when tested according to the Horizontal Flame Test (DIN EN ISO 15025A) for Textiles, as presented herein.

For purposes of this disclosure, the term “textile” as used herein refers to a fabric material made from fibers, filaments, yarns including fibers and/or filaments or a combination thereof. In particular, the term “textile” as used herein refers to a manufactured sheet-like structure (e.g., knitted, woven or nonwoven) made from fibers, filaments and/or yarns.

For purposes of this disclosure, the term “void” as used herein refers to the empty space/volume between tendrils of expanded graphite.

For purposes of this disclosure, the term “corrugated structure” means that the barrier layer shows a corrugated, bunched, wrinkled, arched or puckered configuration as taught in WO 95/32093.

The disclosed laminates having a meltable layer, an intermediate layer comprising a heat reactive material and, optionally, an additional layer can be used as protective clothing. Protective clothing includes garments like jackets, trousers, shirts, vests, overalls, gloves, gaiters, hoods and shoes.

For optimum user performance in environments with the potential for exposure to flash fire or exposure to an electrical arc, and where flexibility of movement is essential, lightweight, stretchable breathable, garments with enhanced burn protection are desired along with soft and drapeable feeling.

Protective clothing needs to be lightweight to be widely used, especially in cases where the danger of a flash fire or an electrical arc is present but of a low probability. To reduce weight of the textile laminate, the weight of the individual layer has to be reduced without losing protective properties or decreasing breathability. Additionally, single-direction or multi-directional stretch and recovery properties are of great significance in applications in articles of protective clothing. Protective clothing articles which are form fitting allow fora closer fit without adversely affecting the wearers comfort. In particular, the ability to stretch the laminate in both the machine and the transverse direction and the ability to recover the stretched amount allow for improved form-fitting characteristics of the three dimensional article made from the two dimensional laminate. In addition, the stretch characteristics allow for other benefits like fewer size requirements, more design flexibility and easier assembly. In articles such as gloves or socks, easy donning and doffing are possible only if the fabric material constituting the article possesses adequate stretch properties. In the absence of such stretch properties, such articles need to be assembled from various pieces, each oriented to provide the needed stretch characteristics in different directions.

The weight properties are influenced significantly by the intermediate layer including the heat reactive material, the heat reactive material including a polymer resin-expandable graphite mixture of a polymer resin. However, a reduced amount of heat reactive material may limit the strengths of the laminate and the ability to maintain its structural integrity under tension.

The solution according to some embodiments is proper selection of the materials, in particular the type and amount of the polymer resin-expandable graphite mixture, and assembly techniques, to form a stretchable flame resistant laminate capable of stretching in one or both of the machine and the transverse direction while maintaining its flame resistant and electrical arc protective characteristics and having good air-permeability and breathability.

For example, in one embodiment, the laminate has an afterflame of less than 2 seconds when tested for flame resistance according using the Horizontal Flame Test, described herein, and is configured to be stretched an amount of at least 10% by a stretching force and to recover at least 80% of the amount stretched when the stretching force is released is described herein.

The laminate is capable of being easily stretched simultaneously in both the machine and the transverse direction and also exhibits excellent recovery from stretching in both directions, i.e., the laminate has elastic properties in both directions. The barrier layers of the laminate can be inherently nonelastic, or inelastic, and may have virtually no recovery properties. Also, the barrier layer may have relatively poor stretch characteristics in one or both directions which must be overcome. Therefore, the elastic behavior of the stretchable laminate results from the properties of the materials with which the barrier layer is combined or from the processing methods used to form the laminate.

In either the machine or transverse direction, the elastic properties can result from the material characteristics of the layers. For example, from the presence of elastomeric yams oriented generally in one or both directions of the knit or woven fabric forming part of the fabric layer, or from the barrier layer which has generally isotropic elastic properties. To overcome limited stretchability or anisotropic stretchability of the barrier layer of the laminate methods such as overfeeding, underfeeding, width control, and the like can be used in adhering the barrier layer to the textile layer. Such methods will be described in detail below.

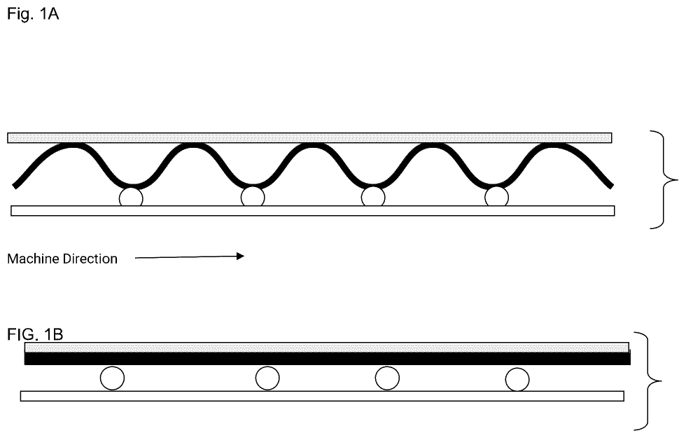

FIG. 1A and FIG. 1B show a cross section of the stretchable laminate in the machine direction in its unstretched or relaxed state (1A) and its stretched state (1B) and further illustrate the various layers of the laminate 2.

Specifically, FIG. 1A shows the unstretched or relaxed laminate 2 with a textile layer 10 that is elastic and includes a meltable material, an intermediate layer 20 located between the textile layer and the barrier layer 30, the intermediate layer including a heat reactive material, wherein the heat reactive material includes a polymer resin-expandable graphite mixture of a polymer resin and an expandable graphite, the expandable graphite having an expansion of at least 900 μm at 280° C., and, a barrier layer 30 includes a polymeric membrane or a textile. The polymeric membrane may include a fluoropolymer, a polyolefin, a polyester, a polyamide, a polyurethane, a copolyetherester, a copolyetheramide, a polysulfone or a polyetheretherketone. The fluoropolymer can include expanded polytetrafluoroethylene (ePTFE) or polytetrafluoroethylene (PTFE).

Optionally, the laminate includes a backer layer providing structural support to the barrier layer. In one embodiment, the textile layer 10 and the barrier layer 30 are adhered to one another by an intermediate layer 20 applied discontinuously in a dot pattern 22, which may also be referred to as adhesion points 22. Upon exposure of the outer side of the textile layer 10 to a flame, the laminate provided with a layer of heat reactive material has an afterflame of less than 20 seconds, when tested according to the Horizontal Flame Test and Self-Extinguishing Test method provided herein.

In the unstretched or relaxed state, the barrier layer 30 assumes a corrugated, bunched, rippled or puckered appearance. The laminate 2 is configured to be stretched an amount of at least 10% by a stretching force and to recover at least 80% of the amount stretched when the stretching force is released.

The laminate geometry remains unchanged with the barrier layer being bunched or corrugated in the machine direction and being substantially planar in the transverse direction. In some embodiments where the laminate includes a backer layer 40 the laminate appears substantially planar because the corrugated structure of the barrier layer is covered by the presence of the backer layer.

As shown in FIG. 1B, the length of the barrier layer 30 between adjacent adhesion points 22 in the machine direction is substantially equivalent to the length of the elastic textile layer 10 between the same adhesion points when the stretchable laminate 2 is extended to its elastic recovery limit. The discontinuous adhesive pattern 22 maintains the elastic textile layer 10 in intimate contact with the barrier layer 30, which is substantially inelastic in the machine direction.

The essential features of the laminate geometry remains unchanged with the barrier layer being bunched or corrugated in the machine direction and being substantially planar in the transverse direction. The laminate 2, however, may appear substantially planar because the corrugated structure, for example, the bunching or wrinkling of the barrier layer 30 may optionally be covered by a backer layer.

With proper selection of the materials and assembly techniques, the stretchable flame resistant laminate yields various worthwhile and surprising results.

The present disclosure relates to laminates including a textile layer that is elastic and includes a meltable material; a barrier layer, and an intermediate layer located between the textile layer and the barrier layer, the intermediate layer including a heat reactive material, wherein the heat reactive material includes a polymer resin-expandable graphite mixture of a polymer resin and an expandable graphite, the expandable graphite having an expansion of at least 900 μm at 280° C., and wherein the laminate is configured to be stretched an amount of at least 10% by a stretching force and to recover at least 80% of the amount stretched when the stretching force is released.

The present disclosure further relates laminate including a textile layer that is elastic and includes a meltable material; a barrier layer having less than 5% elasticity and defining a corrugated structure within the laminate; and an intermediate layer including a heat reactive material between the textile layer and the barrier layer; wherein the heat reactive material includes a polymer resin-expandable graphite mixture of a polymer resin and an expandable graphite, the expandable graphite having an expansion of at least 900 μm at 280° C., as measured according to the TMA expansion test.

When the laminate is used to produce a garment having an interior and an exterior, the laminate, whether positioned on the interior of the garment, the exterior of the garment, or between the interior and exterior of the garment, is oriented so that the textile layer is facing or exposed to the exterior area of the garment and the barrier layer, and optionally the backer layer is positioned opposite the textile layer, i.e., is oriented toward the wearer. The disclosure also relates to embodiments wherein, when the textile layer is exposed to a flame or to an electrical arc, the combination of the textile layer and the intermediate layer including a heat reactive material form a char. In some embodiments, the char includes a carbonaceous layer that forms after the textile layer and polymer materials of the heat reactive materials have been burned. The carbonaceous char has a very high melt point and provides insulation for those materials beneath the char.

A wide variety of elastic textiles can be utilized in the laminate, however for most applications it is highly desirable that the stretchable laminate constructions not be too stiff so as to offer excessive resistance to body movements. It has been determined that elastic textiles requiring a force to elongate to 200% of their relaxed length of from about 0.2 kg/cm width to about 0.3 kg/cm width are suitable for preparing stretchable laminate constructions that can be stretched to 200% of their relaxed length by a force of less than about 0.6 kg/cm width.

Suitable elastic textiles can comprise knit textiles, woven textiles or nonwoven textiles. These textiles generally comprise a combination of both elastic and non-elastic fibers, filaments and/or yarns, knitted or woven in such a way as to give the elastic textile the desired stretch properties. Typical elastic fibers, filaments or yarns can include, for example, elastane, polyester ether copolymer, polyurethane, polyester urethane copolymer, polyether urethane copolymer, polyester ether urethane copolymer or a combination thereof. Typical non-elastic fibers, filaments and/or yarns can include, for example, nylon, nylon 6,6, nylon 6, polyester, polyethylene terephthalate, polytrimethylene terephthalate, polypropylene terephthalate, polybutylene terephthalate, polyolefin, polyethylene, polypropylene or a combination or a copolymer thereof. In some embodiments, the fibers, filaments and/or yarns can include additives, for example, hydrophobic additives, dyes or pigments for color, fillers, flame retardants, antioxidants, light stabilizers, anti-statics or a combination thereof.

The laminate can stretch in both the machine and the transverse direction by application of a low amount of stretching load. This is defined by the stretching force which is the force required per unit width to elongate the laminate by a fixed amount in a particular direction. For example, 10% stretching force is the force per unit width required to stretch the laminate by 10% of its original length. The stretching force is an indication of the ease with which the laminate can be stretched. The laminates demonstrate a 10% stretching forceless than 0.15 kg/cm (0.85 pli) width, as measured by the test described herein. Similarly tested, the 50% stretching force of the laminates range from 0.08-0.60 kg/cm (0.45-3.41 pli) depending on the direction of stretching. Due to the low stretching force required, the laminate demonstrates particularly soft and drapeable behavior that is desirable in fabric materials used for form-fitting articles of protective clothing.

The laminate is capable of stretching simultaneously in both the machine and the transverse direction while maintaining its flame resistant characteristics. In some embodiments, the laminate is capable of stretching by at least 10%, preferably by at least 25%, and most preferably by at least 40%, of its original length in both the machine and transverse directions. In addition to the capability to stretch under a load, the laminate should also recover, in both directions, most of its original length when the stretching force is released. In some embodiments, the laminate is capable of recovering at least 50%, preferably 65%, and most preferably at least 80% of the stretched amount.

The textile layer can include a woven, a knit, a non-woven material, or a combination thereof. The textile layer may be a multilayer textile including one or more of wovens, knits and/or nonwoven textiles. Elastic textiles may include woven, nonwoven or knitted fabrics. The elastic textile may include hard or non-elastomeric fiber and an elastic fiber. Textiles which are suitable as the textile layer can include, for example nylon, nylon 6, nylon 6.6; polyester, polyethylene terephthalate, polytrimethylene terephthalate, polybutylene terephthalate; polyurethane, polyolefin, polyethylene, polypropylene, elastane, cotton or a combination thereof.

In some embodiments, the textile layer may have a hydrophobic treatment to help lower the water absorption of the laminate. Suitable hydrophobic treatments may include, fluorochemical treatments and/or silicone-based treatments. Or, in other embodiments, the textile layer may have an insecticidal or insect repellant treatment applied, for example, permethrin or DEET. The textile layer may have a hydrophilic or oleophobic treatments in order to impart water-wicking or dirt-repelling properties to the laminate.

In some embodiments, the textile layer can be light weight. For example, the textile layer according to any of the previous embodiments, can have a weight of about 120 grams per square meter (g/m²) or less, about 110 g/m² or less, about 100 g/m2 or less, about 90 g/m² or less, about 80 g/m² or less, about 70 g/m² or less, 60 g/m², about 50 g/m² or less, about 45 g/m² or less, about 40 g/m² or less, about 35 g/m² or less, about 30 g/m² or less, about 25 g/m² or less, or about 20 g/m² or less. All weight measurements are performed by DIN EN 12127 (1997/12).

In some embodiments, the meltable material can include polyamides, for example nylon, nylon 6, nylon 6.6; polyester, polyethylene terephthalate, polytrimethylene terephthalate, polybutylene terephthalate; polyurethane; polyolefin, polyethylene, polypropylene, elastane and combinations thereof. The meltable material may include a polyester or a polyamide having at least some aliphatic groups. The meltable material may be produced from aliphatic diols, diamines and diacids.

In some embodiments, the meltable material may be flammable, and include but are not limited to polyamides such as nylon 6 or nylon 6,6, polyester, and polypropylene. In some embodiments, the textile layer can include a meltable, non-flammable textile. Meltable, non-flammable textiles, include, for example, phosphonate modified polyesters (such as materials sold under the trade name TREVIRA® CS and AVORA® FR). Some meltable, non-flammable textiles are not typically intended for use in flame resistant laminates intended for garment applications because when constrained in traditional laminate form, the textile cannot readily shrink away from flames, resulting in continued burning. However, it has been found that when the textile laminate further includes a backer layer and a heat reactive material between, the textile laminates may be used in flame resistant laminate applications.

The laminate also includes a barrier layer which can include a polymeric membrane or a textile. In some embodiments, the polymeric membrane may include a fluoropolymer, a polyolefin, a polyester, a polyamide, a polyurethane, a copolyetherester, a copolyetheramide, a polysulfone or a polyetheretherketone. The fluoropolymer can include expanded polytetrafluoroethylene (ePTFE) or polytetrafluoroethylene (PTFE). The preferred polymeric membrane material is expanded, microporous polytetrafluoroethylene (ePTFE). These materials are characterized by a multiplicity of open, interconnecting microscopic voids, high void volume, high strength, soft, flexible, stable chemical properties, high water vapor transfer, and a surface that exhibits good contamination control characteristics. U.S. Pat. Nos. 3,953,566 and 4,187,390 describe the preparation of such microporous expanded polytetrafluoroethylene membranes and are incorporated herein by reference. The barrier layer, for example, may include microporous ePTFE membranes with a weight of 2 to 50 gram/m2, but the range of 2 to 30 gm/m2 is preferred.

The barrier layer can also be a thermally stable textile layer. The barrier layer may be a combination of a textile layer and a thermally stable textile layer.

In certain embodiments, the barrier layer can include one or more of: an aramid, flame resistant cotton, cotton, flax, cupro, acetate, triacetate, wool, viscose, polybenzimidazole (PBI), polybenzoxazole (PBO), FR rayon, modacryl, modacryl/cotton blend, polyamine, fiberglass, polyacrylonitrile, nylon, polyester or polypropylene fibers or a combination thereof.

In certain embodiments, the barrier layer has less than 5% elasticity and is defined by a corrugated structure within the laminate.

The intermediate layer is located between the textile layer and the barrier layer. To prepare the laminate, the intermediate layer can be applied to the barrier layer, the textile, or to both, the textile layer and the barrier layer. The intermediate layer may be applied in a continuous pattern. The intermediate layer may be applied in a discontinuous pattern. A discontinuous layer of the intermediate layer may have less than 100% surface coverage by patterns that may include one or more of dots, shapes, circles, squares, triangles, stars, diamonds, pentagons, hexagons, heptagons, octagons, polygons, ovals, grids, lines, waves, zig-zag lines and the like. Applying the intermediate layer as a discontinuous layer may enhance air-permeability, water vapor permeability and/or hand. As used herein, the term “dot” means any shape that may be any discrete shape, for example, one or more of a circle, a square, a rectangle, a triangle, a diamond, a pentagon, a hexagon, a heptagon, an octagon, an oval, a polygon, a star, a heart and the like. The lines may have a straight shape, a corrugated shape, a curved shape or mixtures thereof. Depending on the pattern, the dots and lines may be arranged closer or wider to each other. The lines may be arranged in the form of a grid.

In some embodiments with discontinuous coverage in a dot pattern, the dots may have a diameter in the range of greater than or equal to from about 0.8 mm to about 5 mm. The dots may have a diameter in the range of from about 0.9 mm to about 4.5 mm. The dots have a diameter in the range of from about 1.0 mm to about 4.0 mm. The dots may have a diameter in the range of from about 1.0 mm to about 3.5 mm. The dots may have a diameter in the range of from about 1.0 to about 3.0 mm. The dots may have a diameter in the range of from about 1.0 mm to about 2.5 mm. The dots may have a diameter in the range of from about 1.0 mm to about 2.25 mm. The dots may have a diameter in the range of from about 1.0 mm to about 2.2 mm. The dots may have a diameter in the range of from about 1.0 mm to about 2.1 mm. The dots may have a diameter in the range of from about 1.0 mm to about 2.0 mm.

In some embodiments with discontinuous coverage, the average distance between adjacent areas of the discontinuous pattern is less than the size of an impinging flame. In some embodiment with discontinuous coverage, the average distance between adjacent areas of the discontinuous pattern is less than 10 mm, or less than 5 mm, or preferably less than 3.5 mm, or 2.5 mm or less, or 1.5 mm or less, or 0.5 mm or less. For example, in a dot pattern printed onto a substrate, the spacing between the dots would be measured. An average distance between adjacent areas of the discontinuous pattern may be greater than 40 um, or greater than 50 um, or greater than 100 um, or greater than 200 um, depending on the application. Average dot spacing measured to be greater than 200 micro m and less than 500 micro m is useful in some laminates described herein.

The intermediate layer may cover in the range of from about 20% to about 100% of the surface area of the textile layer and/or the barrier layer. The intermediate layer may cover in the range of from about 25% to about 80% of the surface area of the textile layer and/or the barrier layer. The intermediate layer may cover in the range of from about 25% to about 75% of the surface area of the textile layer and/or the barrier layer. The intermediate layer may cover in the range of from about 25% to about 55% of the surface area of the textile layer and/or the barrier layer. The intermediate layer may cover in the range of from about 25% to about 40% of the surface area of the textile layer and/or the barrier layer. The intermediate layer may cover in the range of from about 25% to about 35% of the surface area of the textile layer and/or the barrier layer.

The intermediate layer may cover in the range of from about 30% to about 100% of the surface area of the textile layer and/or the barrier layer. The intermediate layer may cover in the range of from about 45% to about 100% of the surface area of the textile layer and/or the barrier layer. The intermediate layer may cover in the range of from about 55% to about 100% of the surface area of the textile layer and/or the barrier layer. The intermediate layer may cover in the range of from about 65% to about 100% of the surface area of the textile layer and/or the barrier layer. The intermediate layer may cover in the range of from about 70% to about 100% of the surface area of the textile layer and/or the barrier layer. The intermediate layer may cover in the range of from about 95% to about 100% of the surface area of the textile layer and/or the barrier layer.

The intermediate layer may cover in the range of from about 30% to about 70% of the surface area of the textile layer and/or the barrier layer. The intermediate layer may cover in the range of from about 45% to about 65% of the surface area of the textile layer and/or the barrier layer. The intermediate layer may cover in the range of from about 25% to about 50% of the surface area of the textile layer and/or the barrier layer. The intermediate layer may cover in the range of from about 65% to about 90% of the surface area of the textile layer and/or the barrier layer. The intermediate layer may cover in the range of from about 70% to about 80% of the surface area of the textile layer and/or the barrier layer.

These ranges of coverage of the layers with an intermediate layer of less than 100% may improve properties of the laminate such as air-permeability, hand, breathability, and/or textile weight. For example, applying the intermediate layer to the textile layer and/or the barrier layer in a deposition from about 20% to about 95% may result in a laminate with increased air-permeability, breathability, increased hand and decreased weight compared to a textile laminate in which the intermediate is applied as a continuous layer with 100% coverage of the textile and/or barrier layer.

In some embodiments, upon exposure of the laminate to flames and/or heat, for example, a temperature greater than or equal to about 280° C., the meltable material may begin to melt and the melt may mix with the heat reactive material, especially with the expanding graphite. This process can also form a char of the meltable material and the heat reactive material. The char resulting from exposure of the meltable material and the heat reactive material to heat and/or high temperatures, for example, greater than or equal to about 280° C., may be a heterogeneous melt mixture including at least the meltable material and the expanded expandable graphite. A char, according to this disclosure, is meant to refer to the carbonaceous material remaining after exposing the meltable material and the heat reactive material to a temperature of greater than or equal to about 280° C. At temperatures greater than or equal to about 280° C., one or both of the meltable material and the polymeric resin may also oxidize or participate in the combustion process forming additional carbonaceous material that becomes part of the char. The formation of the char can help to insulate the layers below of the char from exposure to heat.

In some embodiments, the heat reactive material, upon expansion, forms a plurality of tendrils including expanded graphite. During the expansion process, the total volume of the heat reactive material may increase significantly when compared to the same mixture prior to expansion. The volume of the heat reactive material may be increased at least about five times after expansion. The volume of the heat reactive material may be increased at least about six times after expansion. The volume of the heat reactive material may be increased at least about seven times after expansion. The volume of the heat reactive material may be increased at least about eight times after expansion. The volume of the heat reactive material may be increased at least about nine times after expansion. The volume of the heat reactive material may be increased at least about ten times after expansion.

In embodiments where the laminate includes a textile layer, a barrier layer and an intermediate layer including the heat reactive material applied in a pattern of discontinuous forms (as is shown, for example) in FIG. 1A, the heat reactive material may expand forming tendrils that are loosely packed after expansion creating voids between the tendrils, as well as space between the pattern of the expanded heat reactive material. Upon exposure to flame, the meltable material may melt and generally move away from the open areas between the discontinuous forms of the heat reactive material. The barrier and/or backer layer may support the heat reactive material during expansion and the melt of the textile layer and/or meltable material may be absorbed and retained by the expanding heat reactive material during melting. By absorbing and retaining the melt, the laminate described herein may exhibit no melt-dripping. By absorbing and retaining the melt, the laminate described herein may be non-flammable, as measured by the Horizontal Flame Test described herein. Where the barrier layer supports the expanding heat reactive material during melt absorption, the thermally stable backer layer may be protected from breaking open and hole formation. The increased surface area of the heat reactive material upon expansion may allow for absorption of the melt from the textile layer by the expanded heat reactive material upon exposure to flame.

In some embodiments, the laminate may exhibit no melt drip, no hole formation and no spreading of the flame or glow to the edges thereof.

The intermediate layer includes a heat reactive material including a polymer resin-expandable graphite mixture of a polymer resin and an expandable graphite.

Polymer resins having a melt or softening temperature of less than 280 degrees centigrade are suitable for use in disclosed embodiments. In some embodiments, polymer resins described herein are sufficiently flowable or deformable to allow the expandable graphite to expand substantially upon heat exposure at or below 300 C, preferably at or below 280 degrees centigrade. Other polymer resins suitable for use in the heat reactive material allow the expandable graphite to sufficiently expand at temperatures below the pyrolysis temperature of the meltable outer textile. It may be desirable that the extensional viscosity of a polymer resin is low enough to allow for the expansion of expandable graphite and high enough to maintain the structural integrity of the heat reactive material after expansion of the mixture of polymer resin and expandable graphite. In another embodiment a polymer resin is used which has a storage modulus between 103 and 108 dyne/cm2 and Tan delta between about 0.1 and about 10 at 200 degrees centigrade. In another embodiment a polymer resin is used that has a storage modulus between 103 and 106 dyne/cm2. In another embodiment, a polymer resin is used that has a storage modulus between 103 and 104 dyne/cm2. Polymer resins suitable for use in some embodiments have a modulus and elongation at around 300 C or less, suitable to allow the graphite to expand. Polymer resins suitable for use in some embodiments are elastomeric. Other polymer resins suitable for use in some embodiments are cross-linkable, such as crosslinkable polyurethane such as that sold under the trade name “MOR-MELT” R7001E (from Rohm and Haas). In other embodiments, suitable polymer resins are thermoplastic having a melt temperature between 50 degrees centigrade and 250 degrees centigrade, such as that sold under the trade name “DESMOMELT” VP KA 8702 (from Bayer Material Science LLC). Polymer resins suitable for use in embodiments described herein include polymers which include but are not limited to polyesters, thermoplastic polyurethanes and crosslinkable polyurethanes, and combinations thereof. Other polymer resins may include one or more polymers selected from polyester, polyamide, acrylic, vinyl polymer, polyolefin. Other polymer resins may include silicone or epoxy. Flame retardant materials optionally may be incorporated in the polymer resin, such as melamine, phosphorous, and brominated compounds, metal hydroxides such as alumina trihydrate (ATH), borates, and combinations thereof.

In some embodiments, the polymer resin includes an aqueous acrylic resin. The polymer resin includes at least 25 wt % of an aqueous acrylic resin based on the total weight of the polymer resin and at least one polymer resin that includes vinyl acetate, styrene, polyether, polyester, polyurethane, polyether polyurethane, polyester polyurethane, polycarbonate polyurethane or a copolymer or a blend thereof.

In some embodiments, the polymer resin-expandable graphite mixture, upon expansion, forms a plurality of tendrils including expanded graphite. The total surface area of the polymer resin-expandable graphite mixture increases significantly when compared to the same mixture prior to expansion. In one embodiment, the surface area of the mixture is increased at least five times after expansion. In another embodiment, the surface area of the mixture is increased at least ten times after expansion. In addition, tendrils will often extend outward from the expanded mixture. Where the polymer resin-expandable graphite mixture is situated on a substrate in a discontinuous form, the tendrils will extend to at least partially fill the open areas between the discontinuous domains. In a further embodiment, the tendrils will be elongated, having a length to width aspect ratio of at least 5 to 1. In one embodiment, where a laminate includes a meltable outer textile, a barrier layer and heat reactive material including a polymer resin-expandable graphite mixture applied in a pattern of discontinuous forms, the heat reactive material expands forming tendrils that are loosely packed after expansion creating voids between the tendrils, as well as space between the pattern of the expanded polymer resin-expandable mixture. Upon exposure to flame, the meltable material in the textile layer melts and generally moves away from the open areas between the discontinuous forms of the heat reactive material. The barrier layer supports the heat reactive material during expansion and the melt of the meltable outer textile is absorbed and retained by the expanding heat reactive material during melting. By absorbing and retaining the melt, laminates can be formed that exhibit no melt-dripping and flammability is suppressed. It is believed that where the barrier layer supports the expanding material during melt absorption, the thermally stable textile backer is protected from breaking open and hole formation. The increased surface area of the heat reactive material upon expansion allows for absorption of the melt from the textile layer and/or meltable material by the expanded heat reactive material upon exposure to flame.

The polymer resin-expandable graphite mixture may be produced by a method that provides an intimate blend of polymer resin and expandable graphite, without causing substantial expansion of the expandable graphite. Suitable mixing methods include but not limited to paddle mixer, blending and other low shear mixing techniques. In one method, the intimate blend of polymer resin and expandable graphite particles is achieved by mixing the expandable graphite with a monomer or prepolymer prior to polymerization of the polymer resin. In another method, the expandable graphite may be blended with a dissolved polymer, wherein the solvent is removed after mixing. In another method, expandable graphite is blended with a hot melt polymer at a temperature below the expansion temperature of the graphite and above the melting temperature of the polymer. In methods which provide an intimate blend of polymer resin and expandable graphite particles or agglomerates of expandable graphite, the expandable graphite is coated or encapsulated by the polymer resin prior to expansion of the graphite. In other embodiments, the intimate blend is achieved prior to applying the polymer resin-expandable graphite mixture to a substrate.

Expandable graphite particle size suitable for present invention should be chosen so that the polymer resin-expandable graphite mixture may be applied with the selected application method. For example, where the polymer resin-expandable graphite mixture is applied by a gravure printing techniques, the expandable graphite particle size should be small enough to fit in the gravure cells.

The expandable graphite may expand at least about 900 micrometers upon heating to about 280° C., as measured by the TMA Expansion Test described herein.

In some embodiments, the heat reactive material can include at an FR additive. The FR additive may include nitrogen based materials and/or phosphorous based materials. The at least one FR additive may be melamine. The at least one FR additive may be polyphosphate. The at least one FR additive may be a combination of melamine and polyphosphate. The at least one FR additive may be melamine polyphosphate. A mixture of the expandable graphite and the at least one FR additive may be present in the heat reactive material in the range of from about 5 to about 45 wt % of expandable graphite and about 5 to about 45 wt % of FR additive, based on a total weight of the heat reactive material.

In some embodiments, the heat reactive material may include expandable graphite in the range of from about 5 to about 45 wt %, or from about 5 to about 40 wt %, or from about 5 to about 35 wt %, or from about 5 to about 30 wt %, or from about 5 to about 25 wt %, or from about 5 to about 20 wt %, or from about 5 to about 15 wt % or from about 5 to about 10 wt %. The heat reactive material may include about 10 to about 45 wt % expandable graphite, or from about 10 wt % to about 40 wt %, or from about 10 wt % to about 35 wt %, or from about 15 wt % to about 45 wt %, or from about 15 wt % to about 40 wt %, or from about 15 wt % to about 35 wt % of expandable graphite based on a total weight of the heat reactive material.

The heat reactive material may include at least one FR additive in the range of from about 5 to about 45 wt %, or from about 5 to about 40 wt %, or from about 5 to about 35 wt %, or from about 5 to about 30 wt %, or from about 5 to about 25 wt %, or from about 5 to about 20 wt %, or from about 5 to about 15 wt %, or from about 5 to about 10 wt %. The heat reactive material may include at least one FR additive in about 10 to about 45 wt % expandable graphite, or from about 10 wt % to about 40 wt %, or from about 10 wt % to about 35 wt %, or from about 15 wt % to about 45 wt %, or from about 15 wt % to about 40 wt %, or from about 15 wt % to about 35 wt % of the at least one FR additive, based on a total weight of the heat reactive material.

In certain embodiments, the heat reactive material includes an acrylic polymer and a mixture of expandable graphite and at least one FR additive. The heat reactive material may include in the range of from about 40 to about 90 wt % of acrylic polymer, based on a total weight of the heat reactive material. The heat reactive material may include in the range of from about 10 to about 70 wt % of the mixture of the expandable graphite and the FR additive, based on a total weight of the heat reactive material. The heat reactive material may include in the range of from about 40 to about 80 wt % of acrylic polymer and from about 20 to about 60 wt % of the mixture of the expandable graphite and the FR additive, based on a total weight of the heat reactive material. The percentages by weight as used above are based on the total weight of the heat reactive material minus any volatiles that may be present, for example, water or other organic molecules that may evaporate during the drying and curing process.

In some embodiments, the heat reactive material includes at least one polyhydroxy compound having a molecular weight of less than 1000 g/mol. The polyhydroxy compound may have a molecular weight of less than about 500 g/mol, less than about 250 g/mol, or less than about 100 g/mol. The polyhydroxy compound may be, for example, propane-1,2,3-triol.

In certain embodiments, where the heat reactive material includes an aqueous acrylic resin in which water is subsequently removed, the laminate may have a dry peel strength in the range of from about 5 to about 25 Newtons (N). The laminate may have a dry peel strength in the range of from about 6 to about 25 N. The laminate may have a dry peel strength in the range of from about 7 to about 25 N. The laminate may have a dry peel strength in the range of from about 7 to about 24 N. The laminate may have a dry peel strength in the range of from about 7 to about 23 N. The laminate may have a dry peel strength in the range of from about 7 to about 22 N. The laminate may have a dry peel strength in the range of from about 7 to about 21 N. The laminate may have a dry peel strength in the range of from about 8 to about 22 N. The laminate may have a dry peel strength in the range of from about 8 to about 23 N. The laminate may have a dry peel strength in the range of from about 8 to about 24 N. The laminate may have a dry peel strength in the range of from about 8 to about 25 N. The dry peel strength values are as measured in DIN 54310.

In some embodiments, the laminate includes a backer layer 40 providing structural support to the barrier layer 30. The backer layer can include one or more of: aramid, flame resistant cotton, cotton, flax, cuprammonium rayon (cupro), acetate, triacetate, wool, viscose, polybenzimidazole (PBI), polybenzoxazole (PBO), FR rayon, modacryl, modacryl/cotton blend, polyamine, fiberglass, polyacrylonitrile, polytetrafluoroethylene or a combination thereof.

In some embodiments, the laminate is used in an article of clothing or an article of manufacture, including but not limited garments, e.g., jackets, trousers, shirts, vests, overalls, gloves, gaiters, hoods and shoes, and bivvy bags, tents, covers and the like. The garments may be suitable for use in hazardous environments, and may be breathable and flame resistant, while being lightweight, flexible, and comfortable to wear.

For example, in some embodiments, the laminate has a weight in the range of from about 80 to about 240 grams per square meter (g/m²). The laminate has a weight in the range of from about 80 to about 200 g/m². The laminate has a weight in the range of from about 80 to about 180 g/m². The laminate has a weight in the range of from about 80 to about 165 g/m². The laminate has a weight in the range of from about 80 to about 150 g/m². The laminate has a weight in the range of from about 80 to about 125 g/m². The laminate has a weight in the range offrom about 80 to about 100 g/m². The laminate has a weight in the range of from about 80 to about 90 g/m².

In some embodiments, the laminate has a weight in the range of from about 95 to about 240 g/m². The laminate may have a weight in the range of from about 110 to about 240 g/m². The laminate may have a weight in the range of from about 125 to about 240 g/m². The laminate may have a weight in the range of from about 140 to about 240 g/m². The laminate may have a weight in the range of from about 165 to about 240 g/m². The laminate may have a weight in the range of from about 180 to about 240 g/m².

In certain other embodiments, the laminate may have a weight in the range of about 115 to about 160 g/m². The laminate has weight in the range of from about 95 to about 150 g/m². The laminate has a weight in the range of from about 165 to about 190 g/m². The laminate has a weight in the range of from about 135 to about 175 g/m². The laminate has a weight in the range of from about 85 to about 100 g/m². All weight measurements are performed by DIN EN 12127 (1997/12).

Furthermore, in some embodiments, the laminate includes a material having an air permeability of at least about 50 l/m²s, measured according to DIN ISO 9237 (1995). In other embodiments, the laminate includes a material having an air permeability greater than about 50 l/m²s. In other embodiments, the laminate includes a material having an air permeability from about 50 l/m²s to about 500 l/m²s, measured according to DIN ISO 9237 (1995). In other embodiments, the laminate includes a material having an air permeability from about 75 l/m²s to about 500 l/m²s, or from about 100 l/m²s to about 500 l/m²s, or from about 125 l/m²s to about 500 l/m²s, or from about 150 l/m²s to about 500 l/m²s, or from about 175 l/m²s to about 500 l/m²s, or from about 50 l/m²s to about 100 l/m²s, or from about 75 l/m²s to about 100 l/m²s, or from about 120 l/m²s to about 150 l/m²s, or from about 130 l/m²s to about 170 l/m²s, or from about 140 l/m²s to about 180 l/m²s, or from about 150 l/m²s to about 190 l/m²s, measured according to DIN ISO 9237 (1995). Optionally, in other embodiments, the laminate includes a material having an air permeability greater than about 150 l/m²s, measured according to DIN ISO 9237 (1995). It is understood that properties such as air permeability may be reduced for certain embodiments, depending, for example, on the specific composition of the textile layer, the barrier layer, the intermediate layer and, optionally, the backer layer.

The laminate is liquid water impermeable and water vapor permeable to the extent of having a water vapor transmission rate (MVTR) of greater than about 1000 g/m²/24 hrs, or greater than about 2000, or greater than about 3000, or greater than about 5000, or greater than about 7000, or greater than about 9000, or greater than about 10000, or higher. The water vapor transmission rates are determined by the method described herein. Preferred laminates have a break open time greater than about 50 seconds, greater than about 60 seconds, or even greater than 120 seconds when tested according to the methods for Horizontal Flame Test described herein. Preferable laminates also have an afterflame less than 20 seconds when tested according to the Horizontal Flame Test and Self-Extinguishing Test methods described herein.

In some embodiments, the laminate has an afterflame of equal or less than about 2 seconds, of equal or less than about 1.5 seconds, of equal or less than about 1 second, or of equal or less than about 0.5 seconds when tested according to the DIN EN 15025A (April 2017) test standard. Upon exposure of an outer side of the textile layer to a flame, the meltable material provided within that layer may shrink away from flames. The meltable layer may melt while the heat reactive material within the intermediate layer, expands, absorbing the heat energy and the melting textile, to keep the meltable layer from burning and dripping onto the wearer. The combination of the melting of the meltable material and the expansion of the heat reactive material may allow for a lightweight stretchable laminate that is able to provide excellent comfort to a wearer and still provide protection from burns. The laminate exhibit substantially no melt dripping behavior when tested in the Horizontal Flame test.

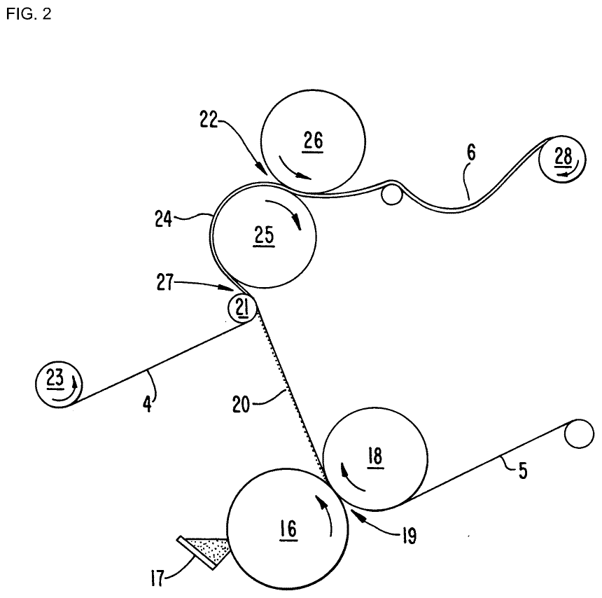

FIG. 2 is a schematic illustration of one embodiment of the process for producing the laminate.

A discontinuous dot pattern of a heat reactive material including a polymer resin-expandable graphite mixture is metered onto one of the surface of the barrier layer 30 by a gravure roll 16 in such a manner as to provide coverage in the range of from approximately 25 to 40% of the barrier layer surface, forming the intermediate layer 20 of the laminate 2. In another embodiment, the heat reactive material is applied to the stretched elastic textile. In yet another embodiment, the heat reactive material is applied to the stretched elastic textile and barrier layer.

In some embodiments, the intermediate layer is applied in a continuous pattern. In some embodiments, the intermediate layer is applied in a discontinuous pattern of any suitable shape or form. For example, the pattern may include one or more of dots, shapes, circles, squares, triangles, stars, diamonds, pentagons, hexagons. A discontinuous layer of the intermediate layer may have less than 100% surface coverage. Applying the intermediate layer as a discontinuous layer may enhance air-permeability, water vapor permeability and/or hand of the laminate.

The doctor knife/adhesive reservoir 17 and the gravure roll 16 are heated to about 50° C. The barrier layer is held under minimal tension against the gravure roll by a low durometer rubber roll 18 at a pressure sufficient to effect removal of the adhesive dots onto the surface of the barrier layer 30.

On exiting the printing nip 19 the barrier layer 30 coated with the intermediate layer 20 is brought to the laminating roll 21 where it is brought in intimate contact with the elastic fabric 10 being held in a stretched state by ensuring that the speed of the exit nip 29 is higher than that of the feed roll 23. Control of the stretch of the elastic fabric 10 at this stage of the process is critical as the stretch properties of the final laminate in the machine direction will depend on it.

Typically, the fabric is stretched in the machine direction such that its width is reduced to about 50% to 90% of its initial width. If the elongation of the elastic fabric is too low, the stretch properties of the resulting laminate will be low and the stretching force will be high in the machine direction. Excessive elongation of the elastic fabric, however, must be avoided because this may lead to inelastic deformation of the fabric in the machine direction.

The laminate created by the uncured intermediate layer 20 is then wrapped around a roll 25 and heated to a temperature suitable for curing the heat reactive material including the polymer resin—expandable graphite mixture. During this curing stage, the laminate is held under tension against the heated roll 25 and the curing time is controlled by the degree of wrap around this roll as well as the speed at the exit nip 29. The exit nip is formed by a rubber roll 26 exerting pressure against the heated roll 25 while being maintained at ambient temperature. During this the hot roll and that the tension of the laminate between the roll 21 and nip curing stage, it is preferred that the barrier layer of the laminate 2 is in contact with 29 is the same as that of the elastic fabric between the feed roll 23 and the nip 27.

Upon exiting nip 29, the laminate 2 is immediately allowed to relax by taking it up on a roll 28 while maintaining the laminate under no tension. Allowing the laminate to cool in a relaxed state is critical in maintaining the machine direction stretch properties of the laminate. If the laminate is taken up under tension, the stretch properties of the laminate are adversely affected due to deterioration of the stretch characteristics of the elastic fabric.

In addition to the process described in FIG. 2, the stretchable laminate can also be produced by different techniques depending on the form and nature of the heat reactive material. It is key, however, that the heat reactive material is capable of bonding the barrier layer to the stretched elastic fabric such that the adhesive junctions are not disturbed when the laminate is returned to the relaxed state. This can be achieved in different ways. The preferred process uses thermal activation of the heat reactive material. In some embodiments, the heat reactive material includes thermoplastic or thermosetting adhesives. Thus, alternatively, cooling of a thermoplastic adhesive may be used to create such adhesive junctions. Another alternative is to use a high green strength thermosetting adhesive to create such adhesive junctions which are then subsequently reacted for added adhesive strength.

In some embodiments, the expandable graphite is configured to expand by at least 900 μm at 280° C.;

In some embodiments, the process includes applying one or more treatments to the elastic textile to improve the properties of the laminate. For example, the elastic textile may have a hydrophobic treatment to help lower the water absorption of the laminate. Suitable hydrophobic treatments can include, fluorochemical treatments and/or silicone-based treatments. The elastic textile may have an insecticidal or insect repellant treatment applied, for example, permethrin or DEET. In other embodiments, the elastic textile may include hydrophilic or oleophobic treatments in order to impart the desired water-wicking or dirt-repelling properties to the laminate. Such treatments can be applied to the elastic textile prior to formation of the laminate. Alternatively, they can be applied after formation of the laminate.

In some embodiments, the process may include heating the laminate in an overfeed without stretching tension.

In some embodiments, achieving a coverage of less than 100% includes applying or printing the intermediate layer including the heat reactive material onto a surface of the textile layer or the barrier layer or both. Suitable application, printing or deposition methods for the heat reactive material include, but are not limited to, screen printing, rotary screen printing, gravure printing, spray or scatter coating, or knife coating. Screen printing or rotary screen printing of the heat reactive material may allow for a higher laydown (when compared to the laydown that can be achieved by a gravure roll) and a low percent area coverage which can allow for a relatively high air permeability of the textile laminate. Using this method, the thickness of the screens may be increased because the heat reactive material may include water. However, after printing, at least a portion of the water may be removed (i.e., evaporated) from the heat reactive material using a heat source, for example, an oven or a heated roll. When water is removed from the heat reactive material during heating, the mass of the heat reactive material may be reduced, resulting in a lighter textile laminate. When at least a portion of the water of the heat reactive material is removed, the mass of the heat reactive material may be reduced as much as about 20% or as much as about 25% or as much as about 30% or as much as about 35% or as much as about 40% or as much as 45%, when compared to the mass of the heat reactive material prior to removal of the water.

Persons skilled in the art will readily appreciate that various aspects of the present disclosure can be realized by any number of methods and apparatuses configured to perform the intended functions. It should also be noted that the accompanying drawing figures referred to herein are not necessarily drawn to scale, but may be exaggerated to illustrate various aspects of the present disclosure, and in that regard, the drawing figures should not be construed as limiting.

### Test Methods

It should be understood that although certain methods and equipment are described below, other methods or equipment determined suitable by one of ordinary skill in the art may be alternatively utilized.

### Horizontal Flame Test

Textile material samples were tested in accordance with DIN EN ISO 15025A (April 2017) test standard. The meltable textile of the samples were exposed to flame for 10 seconds. Afterflame time was averaged for three samples. Textiles with afterflame of greater than two seconds were considered as flammable. Textiles having an afterflame of less than two seconds are considered non-flammable.

Samples of textiles and textile laminates were tested forflame resistance in accordance with the DIN EN 15025A test standard. Samples were exposed to flame for 10 seconds. Textiles and textile laminates with afterflame of greater than two (2) seconds were not considered flame resistant. Textiles and textile laminates having an afterflame of less than two (2) seconds are considered flame resistant.

### Weight

Weight measurements on textile laminates, meltable layers and additional layers described herein were conducted as specified in DIN EN 12127 (December 1997).

### Moisture Vapor Transmission Rate (MVTR)

A description of the test employed to measure moisture vapor transmission rate (MVTR) is given below. The procedure has been found to be suitable for testing films, coatings, and coated products.

In the procedure, approximately 70 ml of a solution consisting of 35 parts by weight of potassium acetate and 15 parts by weight of distilled water was placed into a 133 ml polypropylene cup, having an inside diameter of 6.5 cm at its mouth. An expanded polytetrafluoroethylene (PTFE) membrane having a minimum MVTR of approximately 85,000 g/m2/24 hrs. as tested by the method described in U.S. Pat. No. 4,862,730 (to Crosby), was heat sealed to the lip of the cup to create a taut, leak proof, microporous barrier containing the solution.

A similar expanded PTFE membrane was mounted to the surface of a water bath. The water bath assembly was controlled at 23 degrees centigrade plus 0.2 degrees centigrade, utilizing a temperature controlled room and a water circulating bath.

The sample to be tested was allowed to condition at a temperature of 23 degrees centigrade and a relative humidity of 50 percent prior to performing the test procedure. Samples were placed so the microporous polymeric membrane was in contact with the expanded polytetrafluoroethylene membrane mounted to the surface of the water bath and allowed to equilibrate for at least 15 minutes prior to the introduction of the cup assembly.

The cup assembly was weighed to the nearest 1/1000 g and was placed in an inverted manner onto the center of the test sample.

Water transport was provided by the driving force between the water in the water bath and the saturated salt solution providing water flux by diffusion in that direction. The sample was tested for 15 minutes and the cup assembly was then removed, weighed again within 1/1000 g.

The MVTR of the sample was calculated from the weight gain of the cup assembly and was expressed in grams of water per square meter of sample surface area per 24 hours.

### Air Permeability

Air permeability of the textile laminates described herein was measured as specified in DIN EN ISO 9237 (December 1995).

### Dry Peel Strength

Dry peel strength of the textile laminates described herein was measured as specified in DIN 54310 1980-07.

### TMA Expansion Test

TMA (Thermo-mechanical analysis) was used to measure the expansion of expandable graphite particles. Expansion was tested with TA Instruments TMA 2940 instrument. A ceramic (alumina) TGA pan, measuring roughly 8 mm in diameter and 12 mm in height was used for holding the sample. Using the macroexpansion probe, with a diameter of roughly 6 mm, the bottom of the pan was set the zero. Then flakes of expandable graphite (about 15 mg) about 0.1-0.3 mm deep, as measured by the TMA probe, were put in the pan. The furnace was closed and initial sample height was measured. The furnace was heated from about 25° C. to 600° C. at a ramp rate of 10° C./min. The TMA probe displacement was plotted against temperature; the displacement was used as a measure of expansion.

### Furnace Expansion Test

A nickel crucible was heated in a hot furnace at 300° C. for 2 minutes. A measured sample (about 0.5 grams) of expandable graphite was added to the crucible and placed in the hot furnace at 300° C. for 3 minutes. After the heating period, the crucible was removed from the furnace and allowed to cool and then the expanded graphite was transferred to a measuring cylinder to measure the expanded volume. The expanded volume was divided by the original weight of the sample to get expansion in cubic centimeters/gram.

### DSC Endotherm Test

Tests were run on a Q2000 DSC from TA instruments using Tzero(tm) hermetic pans. For each sample, about 3 milligrams of expandable graphite was placed in the pan. The pan was vented by pressing the corner of a razor blade into the center, creating a vent that was approximately 2 millimeters long and less than 1 millimeter wide. The DSC was equilibrated at 20° C. Samples were then heated from 20° C. to 400° C. at 10° C./minute. Endotherm values were obtained from the DSC curves.

### Melting and Thermal Stability Test

The test was used to determine the thermal stability of textile materials. This test is based on thermal stability test as described in section 8.3 of NFPA 1975, 2004 Edition. The test oven was a hot air circulating oven as specified in ISO 17493. The test was conducted according to ASTM D 751, Standard Test Methods for Coated Fabrics, using the Procedures for Blocking Resistance at Elevated Temperatures (Sections 89 to 93), with the following modifications:
Borosilicate glass plates measuring 100 mm×100 mm×3 mm (4 inches×4 inches×0.12 inches) were used.
A test temperature of 265 degrees centigrade, +3/−0 degrees centigrade (510 degrees Fahrenheit, +5/−0 degrees Fahrenheit) was used.
The specimens were allowed to cool a minimum of 1 hour after removal of the glass plates from the oven.

Any sample side sticking to glass plate, sticking to itself when unfolded, or showing evidence of melting or dripping was considered as meltable. Any sample lacking evidence of meltable side was considered as thermally stable.

The invention of this application has been described above both generically and with regard to specific embodiments. It will be apparent to those skilled in the art that various modifications and variations can be made in the embodiments without departing from the scope of the disclosure. Thus, it is intended that the embodiments cover the modifications and variations of this invention provided they come within the scope of the appended claims and their equivalents.

### Examples

Preparation of Heat Reactive Material #1

A flame retardant polyurethane resin was prepared by first forming a resin according to commonly owned U.S. Pat. No. 4,532,316 and adding a phosphorus-based flame retardant material to the reactor, in an amount of about 20% by weight. After the polyurethane resin was formed, 65 grams of the polyurethane resin was mixed with 24 grams of expandable graphite (the expandable graphite having an expansion of greater than 900 micrometers at 280° C. as determined by the TMA expansion test) and an additional 17 grams of another phosphorus-based flame retardant material at 80° C. in a stirring vessel. The mixture was cooled and used as is.

Preparation of Laminate #1

Laminate #1 was prepared using lamination equipment as shown in FIG. 2. Heat reactive Material #1 was gravure printed onto an ePTFE film, part number 4410012, available from W. L. Gore and Associates, GmbH, Munich Germany. A dot pattern of heat reactive material #1 was metered onto the ePTFE film using a gravure roll heated to 50° C. to provide a coverage of about 40% and an adhesive laydown of 38 to 45 grams/meter². The ePTFE film was held under minimal tension to the surface of the gravure roll using a low durometer rubber roll to print the dots onto one surface of the ePTFE film. The printed surface of the ePTFE film was then bonded to an elastic textile (a 129 gram/meter² polyester twill), where the elastic textile was stretched in the machine direction so as to reduce its width by about 70% of its width in the relaxed state. The 2-layer laminate was then wrapped around a 6 inch chrome roll heated at 180° C. to cure the heat reactive material while maintaining the ePTFE film surface in contact with the chrome roll. About 65% of the hot chrome roll surface was covered by the laminate which was held under tension against the hot chrome roll and moved through the nip created by a low durometer rubber roll at ambient temperature being pressed against the chrome roll at minimal tension. As soon as the laminate exited the nip, it was allowed to cool down in a relaxed state in and accumulated prior to taking it up.

A sample of laminate #1 has two major surfaces, one surface being the elastic textile layer and the second surface is the ePTFE layer. A sample of laminate #1 was stretched 13% in the machine direction, and after the stretch force was removed, recovered 99% of its original length within 30 minutes.

1. A laminate comprising:
a textile layer that is elastic and includes a meltable material;
a barrier layer; and
an intermediate layer located between the textile layer and the barrier layer, the intermediate layer comprising a heat reactive material, wherein the heat reactive material comprises a polymer resin-expandable graphite mixture of a polymer resin and an expandable graphite, the expandable graphite having an expansion of at least 900 μm at 280° C., and
wherein the laminate is configured to be stretched an amount of at least 10% by a stretching force and to recover at least 80% of the amount stretched when the stretching force is released.

2. A laminate comprising:
a textile layer that is elastic and includes a meltable material;
a barrier layer having less than 5% elasticity and defining a corrugated structure within the laminate; and
an intermediate layer including a heat reactive material between the textile layer and the barrier layer;
wherein the heat reactive material comprises a polymer resin-expandable graphite mixture of a polymer resin and an expandable graphite, the expandable graphite having an expansion of at least 900 μm at 280° C., as measured according to the TMA expansion test.

3. The laminate of claim 1, wherein the meltable material is flammable.

4. The laminate of claim 1,
wherein the laminate further comprises a backer layer providing structural support to the barrier layer, wherein the backer layer comprises one or more of: aramid, flame resistant cotton, cotton, flax, cuprammonium rayon (cupro), acetate, triacetate, wool, viscose, polybenzimidazole (PBI), polybenzoxazole (PBO), FR rayon, modacryl, modacryl/cotton blend, polyamine, fiberglass, polyacrylonitrile, polytetrafluoroethylene or a combination thereof.

5. (canceled)

6. The laminate of claim 1, wherein the heat reactive material further comprises at least one flame retardant (FR) additive and at least one polyhydroxy compound having a molecular weight of less than 1000 g/mol.

7. The laminate of claim 1, wherein the textile layer has a stretch of greater than 10% and recovery, or wherein the textile layer includes elastane fibers, or wherein the textile layer is selected from a polyamide and a polyester.

8. (canceled)

9. (canceled)

10. The laminate of claim 1, wherein the laminate has a dry peel strength in the range of from about 5 to about 25 Newtons (N) as measured in DIN 54310.

11. The laminate of claim 1, wherein the intermediate is applied to the textile layer or the barrier layer in a continuous pattern, or wherein the intermediate layer is applied to the textile layer or the barrier layer in a discontinuous pattern of dots.

12. (canceled)

13. The laminate of claim 12, wherein the dots have a diameter in the range of from 0.8 mm to 5 mm.

14. The laminate of claim 1, wherein the heat reactive material covers from about 25% to about 100% of the surface area of the meltable layer.

15. The laminate of claim 1, wherein the barrier layer comprises a polymeric membrane or a textile, wherein the polymeric membrane comprises a fluoropolymer, a polyolefin, a polyester, a polyamide, a polyurethane, a copolyetherester, a copolyetheramide, a polysulfone or a polyetheretherketone.

16. (canceled)

17. The laminate of claim 17, wherein the fluoropolymer comprises expanded polytetrafluoroethylene (ePTFE) or a polytetrafluoroethylene (PTFE).

18. The laminate of claim 1, wherein the laminate has a weight in the range of from about 80 to about 240 grams per square meter (gsm), or wherein the laminate includes a material having an air permeability of at least 50 l/m2s as measured by DIN ISO 9237 (1995), or wherein the laminate is liquid water impermeable and water vapor permeable to the extent of having a water vapor transmission rate of at least 2000 g/m2/24 hrs.

19. (canceled)

20. (canceled)

21. An article of clothing or an article of manufacture comprising the laminate of claim 1, wherein the article of clothing is a garment having an interior and an exterior, and wherein the laminate is positioned on the exterior of the garment.

22. (canceled)

23. The article of clothing of claim 22, wherein the laminate is positioned on the interior of the garment, or wherein the laminate is positioned between the interior and exterior of the garment.

24. (canceled)

25. (canceled)

26. A process for producing a laminate comprising:
imparting a stretching force on an elastic textile having an initial relaxed width in a machine direction so as to stretch the elastic textile and reduce a width of the elastic textile to 90 percent or less of the initial relaxed width;
providing a barrier layer;
applying a layer of a heat reactive material to the stretched elastic textile or the barrier layer or both; wherein the heat reactive material comprises a polymer resin-expandable graphite mixture of a polymer resin and an expandable graphite, and the expandable graphite is configured to expand by at least 900 μm at 280° C.;
adhering the barrier layer to the stretched elastic textile so that the heat reactive material is between the elastic textile and the barrier layer;
curing the heat reactive material while the elastic textile remains stretched; and
reducing the stretching force on the elastic textile to produce the laminate; wherein the barrier layer has a corrugated structure after the stretching force is reduced.

27. The process of claim 27, wherein the process further comprises applying a hydrophobic treatment to the elastic textile of the laminate.

28. The process of claim 27, wherein the process further comprises; heating the laminate in an overfeed without stretching tension.

29. (canceled)

30. The process of claim 27, wherein the heat reactive material comprises at least one flame retardant additive and at least one polyhydroxy compound.
